(19) United States
(12) Patent Application Publication
(10) Pub. No.: US 2017/0044778 A1
(43) Pub. Date: Feb. 16, 2017

(54) IMPACT RESISTANT WEAR LAYER

(71) Applicant: ARMSTRONG WORLD INDUSTRIES, INC., Lancaster, PA (US)

(72) Inventors: MEREDITH L. BRICKNER, Elizabethtown, PA (US); SUNIL RAMACHANDRA, Lancaster, PA (US); KEAN M. ANSPACH, Quarryville, PA (US); JOHN R. ESHBACH, Mount Joy, PA (US); DONG TIAN, Lancaster, PA (US)

(21) Appl. No.: 14/824,261

(22) Filed: Aug. 12, 2015

(51) Int. Cl. E04F 15/10; B32B 38/00; B32B 27/06; B32B 3/06; B32B 27/30; E04F 15/02; B32B 38/10

(52) U.S. Cl. CPC E04F 15/107; E04F 15/02038; B32B 38/0012; B32B 38/10; B32B 3/06; B32B 27/30; B32B 27/06; E04F 2201/0153; E04F 2201/023; B32B 2307/554; B32B 2419/04; B32B 2307/558

(57) ABSTRACT

The invention is directed to dimensionally stable flooring panels that have mechanical locking profiles. The flooring panels having at least two layers that include a wear layer and a substrate layer, wherein the wear layer forms a part of the mechanical locking profiles.

### BACKGROUND

Polymeric flooring systems comprise a plurality of flooring panels that are installed adjacent to one another. Previously, flooring panels having a flush side edge geometry allowed for tight seams between adjacent flooring panels. However, such flush edge geometry tends to allow for relative movement between each flooring panel in the fully installed state when mechanical stress is applied to the flooring system (i.e. walking on the flooring panels). To reduce the amount of relative movement, mechanical locking profiles have been formed in the side edge surfaces of these flooring panels, thereby improving the overall stability of resulting flooring system.

Specifically, mechanical locking profiles provide a first flooring panel having a first edge geometry (e.g. a tongue) and a second flooring panel having a second edge geometry that somewhat occupies the negative space of the first edge geometry (e.g., a groove). When the first and second flooring panels are brought together, the second edge geometry accepts the first edge geometry (or vice versa) causing the first and second flooring panels to interlock. In addition to increase stability, the mechanical locking profiles add to the overall cosmetic appearance of the flooring system by maintaining tight seams between the first and second edges of adjacent flooring panels.

However, creating mechanical locking profiles on polymeric flooring panels that comprise one or more polymeric layers, including a wear layer and a substrate, can be problematic because the polymeric layers require a balance of different performance properties. For example, the flooring panel must exhibit sufficient dimensional stability so that it does not shrink or expand overtime. Additionally, the flooring panel must have smooth edge profile even with the mechanical locking profile. Providing the requisite dimensional stability in the polymer layers, especially the upper wear layer, may create problem with respect to chipping in the side surface of the polymeric layer when the locking profile is machined. Chipping creates a substantially rougher surface texture, which not only undermines the mechanical integrity of the flooring panel, but degrades the overall aesthetic appearance of each flooring panel as well as the seams between each flooring panel in the full installed flooring system.

Conventional polymeric flooring panels, such as vinyl tiles, typically use a plasticized polyvinyl chloride film as the wear layer. However, a plasticized wear layer may pose problems in that the plasticizer tends to migrate to the surface over time and the plasticized wear layer has to be thermally annealed to make the layer dimensionally stable.

Thus, there exists a need for wear layers that can provide desired dimensional stability without a post fabrication treatment and that resist chipping during the creation of the mechanical interlocking profile.

### BRIEF SUMMARY

According to some embodiments, the present invention is directed to a flooring panel comprising a substrate layer and a wear layer atop the substrate layer. The wear layer may comprise a vinyl polymer and an impact modifier. The wear layer may also be substantially free of plasticizer.

In some embodiments, the present invention is directed to a method of forming a flooring panel, tile or sheet. For illustration purposes, the present flooring products are referred to as a flooring panel. The method may first comprise a step of forming a laminate structure comprising a substrate and a wear layer atop the substrate. The wear layer may comprise a vinyl polymer and an impact modifier, and the wear layer may be substantially free of plasticizer. Subsequently, the method may further comprise a step of machining a first edge of the laminate structure to form a first mechanical locking profile, and a second edge of the laminate structure to form a second mechanical locking profile, thereby forming the flooring panel. In some embodiments, the wear layer may form a first portion of each of the first and second mechanical locking profiles. In some embodiments, the substrate layer may form a second portion of each of the first and second mechanical locking profiles.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a flooring panel according to some embodiments of the present invention;

FIG. 2 is a side profile view of a laminate structure according to some embodiments of the present invention;

FIG. 3 is a side profile view of a flooring panel according to some embodiments of the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

For the purpose of this invention, the term “about” means +/−5%. For the purpose of this invention, the phrase “substantially free” means less than 4 wt. % based on the total weight of the referenced composition.

Unless otherwise specified, all percentages and amounts expressed herein and elsewhere in the specification should be understood to refer to percentages by weight. The amounts given are based on the active weight of the material.

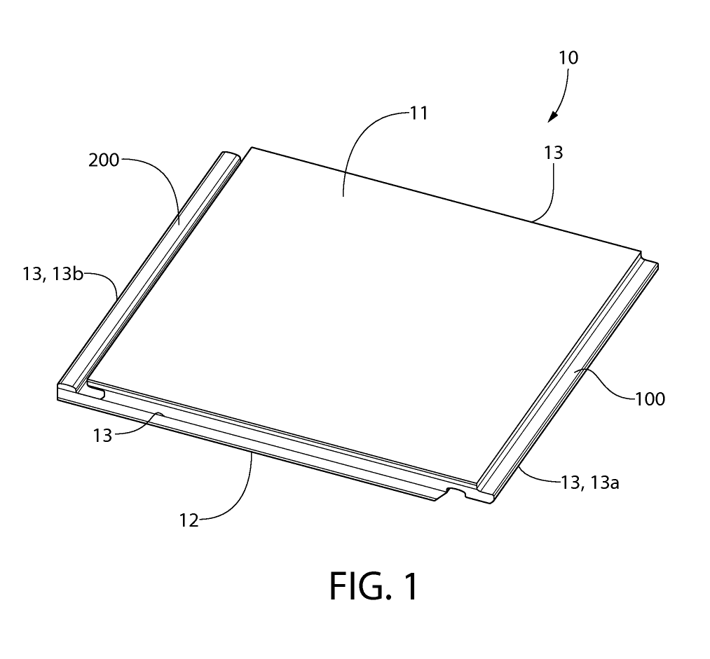

As shown in FIGS. 1 and 3, the present invention is directed to a flooring panel 10 comprising a wear layer 30 and a substrate layer 20, the wear layer 30 atop the substrate layer 20.

The wear layer 30 of the present invention may comprise a polymer and one or more additives. According to some embodiments, the polymer is selected from thermoplastic polymer. In some embodiments, the additives may include impact modifier, filler, pigment, lubricant, stabilizer, and a combination of two or more thereof. Typically, a wear layer is produced by an extrusion or calendaring process.

The polymer may include a vinyl polymer, copolymers thereof, and mixtures of two or more thereof. Non-limiting examples of the vinyl polymer suitable for the wear layer include chlorinated vinyl polymers, such as polyvinyl chloride (PVC), polyvinylidene chloride (PVDC), and copolymers of vinyl chloride and alkene monomer—such as a copolymer of vinyl chloride and vinyl acetate, as well as mixtures thereof. According to some embodiments of the invention, the wear layer 30 of the present invention is substantially free of plasticizer. Without plasticizer, the resulting wear layer 30 exhibits greater dimensional stability over time with exposure to heat and moisture. In a preferred embodiment, the wear layer 30 comprises less than 0.05 wt. % of plasticizer based on the total weight of the wear layer 30. In a preferred embodiment, the wear layer 30 is entirely free (0 wt. %) of plasticizer based on the total weight of the wear layer 30. Non-limiting examples of plasticizer may include low molecular weight phthalate esters. According to the present invention, wear layer 30 that is produced substantially free of plasticizer is not formed from plastisol, as plastisol is a mixture of vinyl polymer resin and plasticizer.

Eliminating the plasticizer from the wear layer 30 of the flooring panel 10 increases dimensional stability. Without the plasticizer the wear layer 30 tends to be brittle and becomes more susceptible to chipping during machining of the laminate structure during the formation of the mechanical locking profiles. Thus, to offset this increased susceptibility, an impact modifier may be present in the wear layer in an amount ranging from 3 wt. % to about 15 wt. %—including all integers and sub-ranges there-between based on the total weight of the wear layer composition. In a preferred embodiment, the impact modifier is present in an amount ranging from about 4 wt. % to about 10 wt. %—including all integers and sub-ranges there-between. According to the present invention, the polymer and the impact modifier may be present in a weight ratio ranging from about 20:1 to about 7:1—including all sub-ranges there-between. In a preferred embodiment, the polymer and impact modifier are present in a weight ratio ranging from about 20:1 to about 16:1.

According to some embodiments, the wear layer 30 may contain a polymer, an impact modifier, a processing aid, a lubricant and a stabilizer. An exemplary wear layer composition may contain a polymer, e.g., PVC, and an impact modifier, e.g., acrylic impact modifier.

A suitable processing aid that improves the processability of a chlorinated polymer, improving such properties as flowability, melt fusability, and surface appearance, includes acrylic polymer processing aids. A suitable processing aid includes PARALOID™ K-120ND, available from Dow Chemical. Lubricants suitable for the invention include acrylic polymer lubricants, such as, PARALOID™ K-175, available from Dow Chemical; fatty acid lubricants, such as stearate metal salt lubricants, e.g., Synpro™ calcium stearate 114, available from Ferror; and combinations thereof. An exemplary wear layer composition may contain polyvinyl chloride, an acrylic impact modifier between 2 and 20 PHR (parts per hundred parts of polymer resin, PVC), an acrylic processing aid between 0.1 and 5 PHR, an acrylic lubricant between 0.1 and 5 PHR, a stearate metal salt lubricant between 0.1 and 5 PHR, and a calcium-zinc stabilizer between 0.1 and 5 PHR. A preferred wear layer composition may contain polyvinyl chloride, an acrylic impact modifier between 5 and 15 PHR (parts per hundred parts of polymer resin, PVC), an acrylic processing aid between 0.5 and 2 PHR, an acrylic lubricant between 0.5 and 2 PHR, a stearate metal salt lubricant between 0.5 and 2 PHR, and a calcium-zinc stabilizer between 0.5 and 2 PHR.

Suitable impact modifiers for the present invention include acrylic impact modifiers (ACR), chlorinated polyethylene (CPE), methyl methacrylate-butadiene-styrene copolymers (MBS), copolyamides, styrene-butadiene-styrene copolymers (SBS), acrylonitrile-butadiene-styrene copolymer (ABS), and a combination thereof. Suitable acrylic impact modifiers include ACRs with a core-shell structure having a crosslinked butyl acrylate core and a grafted methyl methacrylate shell. Suitable chlorinated polyethylene includes a high molecular copolymer of high density polyethylene and chlorine. Suitable methyl-methacrylate, butadiene and styrene copolymers include core-shell copolymer having a butadiene-styrene core and a grafted methyl methacrylate shell. Suitable copolyamides include random copolymers of polyamides including copolyamides based on caprolactam, laurolactam, amino undecyclic acid, and polyethylene glycol, which is typically used as hot melt adhesives, Such suitable material includes, for example, H1937 Platamid® available commercially from Arkema. Of these, preferred are acrylic impact modifiers since acrylic impact modifiers are less susceptible to oxidative degradation.

In some embodiments, the SBS comprises styrene and butadiene in a weight ratio of about 28:72 to about 48:52. In some embodiments, the SBS comprises styrene and butadiene in a weight ratio of about 30:70 to about 40:60. In some embodiments, the SBS comprises about a ratio of about 30:70 of styrene:butadiene. In some embodiments, the ABS comprises 40 wt. % to 50 wt. % of styrene, 25 wt. % to 30 wt. % of butadiene, and 25 wt. % to 30 wt. % of acrylonitrile. In some embodiments, the impact modifier is substantially free of methyl-methacrylate-butadiene-styrene (MBS).

According to some embodiments, the core comprise polybutyl acrylic polymer and the shell may comprise polymethyl-methacrylate.

In some embodiments, the polymeric core may have a glass transition (Tg) that is lower than the Tg of the polymeric shell. According to some embodiments, the polymeric core may have a Tg ranging from about −50° C. to about 60° C. In a preferred embodiment, the Tg of the polymeric core may range from about −20° C. to about 20° C. According to some embodiments, the polymeric shell may have a Tg ranging from about 50° C. to about 110° C.

In some embodiments, the polymeric shell may have a Tg that is lower than the Tg of the polymeric core. The polymeric core may have a Tg ranging from about 50° C. to about 110° C. The polymeric shell may have a Tg ranging from about −50° C. to about 60° C. In a preferred embodiment, the Tg of the polymeric shell may range from about −20° C. to about 20° C.

Some embodiments of the present invention provide that the core-shell polymer particles have an average particle size ranging from about 50 nanometers (nm) to about 5,000 nm—including all sub-ranges and values there between. In one embodiment, the core-shell polymer particles have an average particle size ranging from about 50 nm to about 1,000 nm. In a non-limiting embodiment, the core-shell polymer particles have an average particle size ranging from about 100 nm to about 200 nm.

According to some embodiment of the present invention, the wear layer preferably has a Tensile Energy Absorption (TEA) value greater than about 4.5 Joules/cm², at least (or greater than) about 4.6 Joules/cm², at least (or greater than) about 4.7 Joules/cm², at least (or greater than) about 4.8 Joules/cm², at least (or greater than) about 4.9 Joules/cm², preferably at least (or greater than) about 5 Joules/cm². In some embodiments, the wear layer may have a TEA ranging from about 4.5 Joules/cm² to about 6.0 Joules/cm²—including all sub-ranges and values by a 0.1 Joules/cm² increment there-between. TEA is a measure of the ability of a film to absorb mechanical shocks. TEA can easily be determined by analyzing the relationship between stress and strain in the tensile test ASTM D828-97 (reapproved 2002). The area under the stress-strain curve can be mathematically derived, and then factored into an equation as given in the test method to yield tensile energy absorption (TEA). The higher the TEA in a film, the easier it is to stress the film without it fracturing. It has been found that lower than a desired TEA value leads to chipping when a flooring panel with the wear layer is subjected to machining to profile the locking system.

Referring to the Figures, the flooring panel 10 may further comprise a top panel surface 11 and a bottom panel surface 12 that is opposite the top panel surface 11. In some embodiments, the top panel surface 11 is formed by the wear layer 30. In some embodiments, the bottom panel surface 12 is formed by the substrate layer 20. In some embodiments, the top panel surface 11 is formed by a top coat 40 applied atop the wear layer 30. In some embodiments, the bottom panel surface 12 is formed by an underlayment 50 beneath the substrate layer 20.

The flooring panel 10 may further comprise a plurality of panel edges 13 that extend between the top panel surface 11 and the bottom panel surface 12 of the flooring panel 10. The plurality of panel edges 13 defines a perimeter of the flooring panel 10. The panel edges 13 comprise a first panel edge 13a and a second panel edge 13b opposite the first panel edge 13a.

According to some embodiments, the wear layer 30 may form a first portion of each of the first panel edge 13a and the second panel edge 13b. In some embodiments, the substrate layer 20 may form a second portion of each of the first panel edge 13a and the second panel edge 13b.

According to some embodiments, the first panel edge 13a comprises a first mechanical locking profile 100. According to some embodiments, the second panel edge 13b comprises a second mechanical locking profile 200. The first mechanical locking profile 100 may be configured to accept the second mechanical locking profile 200. The wear layer 30 may form a portion of each of the first mechanical locking profile 100 and the second mechanical locking profile 200.

In some embodiments, the first mechanical locking profile 100 may comprise a first horizontal locking feature 110—which may be in the form of a recess. In some embodiments, the first mechanical locking profile 100 may comprise a first vertical locking feature 120—which may be in the form of a flange. In some embodiments, the second mechanical locking profile 200 may comprise a second horizontal locking feature 210, which may be in the form of a lip. In some embodiments, the second mechanical locking profile 200 may comprise a second vertical locking feature 220, which may be in the form of a flange.

The first horizontal locking feature 110 may be configured to cooperate with the second horizontal locking feature 210 to provide horizontal locking between adjacent flooring panels 10. The first vertical locking feature 120 may be configured to cooperate with the second vertical locking feature 220 to provide horizontal locking between adjacent flooring panels 10.

The first horizontal locking feature 110 comprises a first horizontal locking wall 111 and a second horizontal locking wall 112 that faces the first horizontal locking wall 111. The first vertical locking feature 120 comprises a first vertical locking surface 121 and a second vertical locking surface 122 that is opposite the first vertical locking surface 121. The first vertical locking feature may further comprise a first distal surface 123 that extends from the first vertical locking surface 121 to the second vertical locking surface 122 in a direct that is either oblique to or at a right angle to at least one of the first or second vertical locking surfaces 121, 122. The first vertical locking surface 121 may face substantially the same direction as the top panel surface 11 of the flooring panel 10. The second vertical locking surface 122 may face substantially the same direction as the bottom panel surface 12 of the flooring panel 10.

According to some embodiments of the present invention, the substrate layer 20 may form the first horizontal locking wall 111 and the second horizontal locking wall 112 of the first horizontal locking feature 110. According to some embodiments of the present invention, the substrate layer 20 may form the first vertical locking surface 121, the second vertical locking surface 122, and the first distal surface 123 of the first vertical locking feature 120.

The second horizontal locking feature 210 comprises a third horizontal locking wall 211 and a fourth horizontal locking wall 212 that is opposite the third horizontal locking wall 211. The second vertical locking feature 220 comprises a third vertical locking surface 221 and a fourth vertical locking surface 222. The third vertical locking surface 221 faces substantially the same direction as the bottom panel surface 12 of the flooring panel 10. The fourth vertical locking surface 222 faces substantially the same direction as the top panel surface 11 of the flooring panel 10.

According to some embodiments of the present invention, the substrate layer 20 may form the third horizontal locking wall 211 and the fourth horizontal locking wall 212 of the second horizontal locking feature 210. According to some embodiments of the present invention, the substrate layer 20 may form the third vertical locking surface 221, the fourth vertical locking surface 222 of the second vertical locking feature 220.

In some embodiments, a flooring system may be installed by positioning a first flooring panel and a second flooring panel adjacent to each other and locking the first mechanical locking profile 100 of the first flooring panel with the second mechanical locking profile 200 of the second flooring panel. Specifically, the first horizontal locking wall 111 of the first flooring panel 10 may be immediately adjacent to, preferably abutting, the third horizontal locking wall 211 of the second flooring panel 10. The first vertical locking surface 121 of the first flooring panel 10 may be immediately adjacent to, preferably abutting, the third vertical locking surface 221 of the second flooring panel 10.

In some embodiments of the present invention, each of the first panel edge 13a and the second panel edge 13b comprises an upper portion 300 that is adjacent to the top panel surface 11 of the flooring panel 10. The upper portion 300 of the first panel edge 13a may comprise a first recess 130. The first recess 130 may comprise a recess wall surface 131 that extends from the top panel surface 11 toward the bottom panel surface 13 in a direction that is either oblique or at a right angle to the top panel surface 11. The first recess 130 may further comprise a recess floor surface 132 that extends from the recess wall surface 131 toward the first distal surface 123 of the first vertical locking feature 120. The recess floor surface 131 may be coplanar with the first vertical locking surface 121 of the first vertical locking feature 120. In some embodiments, the recess floor surface 132 may extend outward from the recess wall surface 131 in a direction that is substantially parallel to at least one of the top panel surface 11 and the bottom panel surface 12.

According to some embodiments of the present invention, the wear layer 30 forms a portion of the recess wall surface 131 of the first recess 130. According to some embodiments of the present invention, the substrate layer 20 forms a portion of the recess wall surface 131 of the first recess 130. According to some embodiments of the present invention, the substrate layer 20 forms the recess floor surface 132 of the first recess 130. According to some embodiments, a top coat 40 forms a portion of the recess wall surface 131.

In some embodiments, the upper portion of the second panel edge 13b comprises a first flange 140. The first flange 140 may comprise a distal surface 141. In some embodiments, the distal surface 141 of the first flange 140 may extend from the top panel surface 11 toward the bottom panel surface 13 in a direction that is either oblique or at a right angle to the top panel surface 11. In some embodiments, the distal surface 141 of the first flange 140 may extend from the top panel surface 11 to the third vertical locking 221 of the second vertical locking feature 220. According to some embodiments, the wear layer 30 forms a portion of the distal surface 141 of the first flange 140. According to some embodiments, the substrate layer 20 forms a portion of the distal surface 141 of the first flange 140. According to some embodiments, a top coat layer 40 forms a portion of the distal surface 141 of the first flange 140.

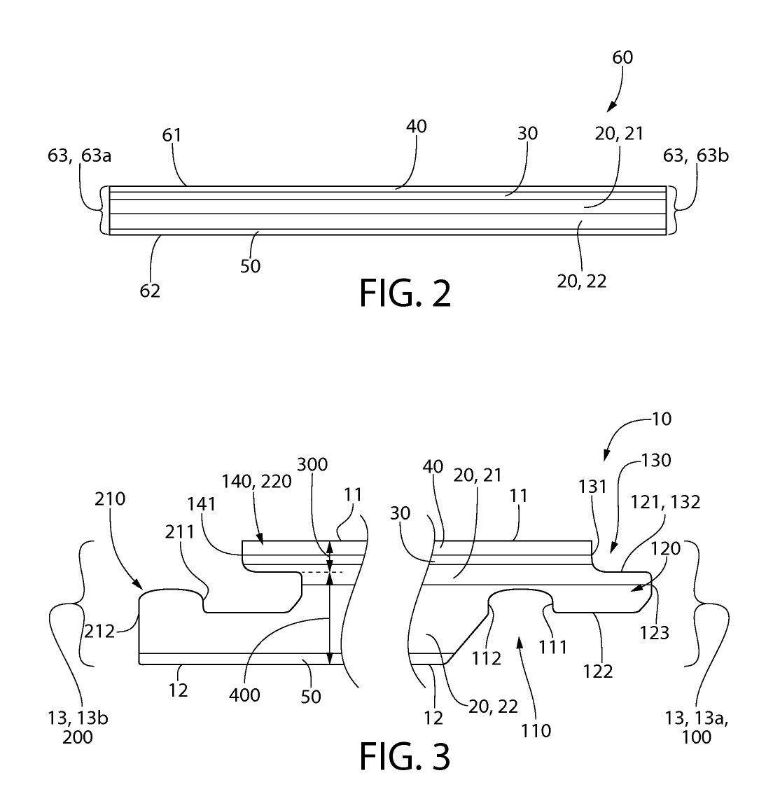

According to some embodiments, the flooring panel 10 having the first mechanical locking profile 100 and the second mechanical locking profile 200 may be formed by first creating a laminate structure 60, as shown in FIG. 2. The laminate structure 60 may be formed by coupling the wear layer 30 and the substrate layer 20 together—the wear layer 30 being atop the substrate layer 20. The laminate structure 60 may further comprise one or more additional layers, as described herein.

The laminate structure 60 may comprise a top laminate surface 61, a bottom laminate surface 62, and a plurality of laminate edges 63 that extend between the top and bottom laminate surfaces 61, 62. The laminate edges 63 may comprise a first laminate edge 63a and a second laminate edge 63b that is opposite the first laminate edge 63a. The wear layer 30 forms a first portion of each of the first laminate edge 63a and the second laminate edge 63b. In some embodiments, the first and second laminate edges 63a, 63b are then machined by a suitable blade from a machining apparatus. A non-limiting example of a machining apparatus is a router comprising a rotating router blade.

According to some embodiments of the present invention, machining the first laminate edge 63a with the suitable blade forms the first mechanical locking profile 100 of the first panel edge 13a—such that the wear layer 30 forms a first portion of the first mechanical locking profile 100 and the substrate layer 20 form a second portion of the first mechanical locking profile 100. According to some embodiments of the present invention, machining the second laminate edge 63b with the suitable blade forms the second mechanical locking profile 200 of the second panel edge 13b—such that the wear layer 30 forms a first portion 300 of the second mechanical locking profile 200 and the substrate layer 20 form a second portion 400 of the second mechanical locking profile 200.

In some embodiments, during the formation of the flooring panel 10, specifically during the machining of at least one of the first laminate edge 63a or the second laminate edge 63b, at least a portion of the wear layer 30 is removed by the blade during machining. Using the wear layer 30 formulation of the present invention provides first and second panel edges 13a, 13b—including the first and second mechanical locking profiles 100, 200—that are substantially free of chips and have a smooth surface texture.

In some embodiments, the wear layer 30 may have a thickness ranging from about 3 to about 40 mil, preferably from about 5 to about 20 mil—including all integers and sub-ranges there-between.

In some embodiments, the substrate layer 30 of the flooring panel 10 may have an overall thickness ranging from about 60 to about 200 mil—including all integers and sub-ranges there-between. Some embodiments provide that the substrate layer 20 may be comprised of a single core layer comprised of binder and filler (not pictured). Such single core layer have a thickness ranging from 50 to 150 mil. As shown in FIG. 3, some embodiments provide that the substrate layer 20 is comprised of multiple core layers—including at least an upper core layer 21 and a lower core layer 22, the upper core layer 21 being atop the lower core layer 22.

In some embodiments the upper core layer 21 comprises a first amount of binder and filler and the lower core layer 22 comprises a second amount of binder and filler, wherein the first amount of binder and filler is either the same or different than the second amount of binder and filler. In a preferred embodiment, the first amount of binder and filler is different than the second amount of binder and filler. The upper core layer 21 may have a thickness ranging from about 30 to about 100—including all integers and sub-ranges there-between. The lower core layer 22 may have a thickness ranging from about 30 to about 100—including all integers and sub-ranges there-between.

According to some embodiments, an intermediate core layer 23 may be positioned between the upper core layer 21 to the lower core layer 22. In some embodiments, the intermediate core layer 22 may be an adhesive, a thermal and/or acoustical insulating material, or a combination thereof.

In some embodiments, the binder of the core layers (i.e. the single core layer, the upper core layer 21, the lower core layer 22) may comprise addition polymers, such as acrylic polymers and vinyl polymers, condensation polymers, or a combination of two or more thereof. Non-limiting examples of vinyl polymer include polyvinyl chloride (PVC), polyvinylidene chloride (PVDC), copolymers of vinyl chloride and alkene monomer, as well as mixtures thereof. Non-limiting examples of condensation polymers include polyester, polyamide, and polyurethane. In some embodiments, the filler may include particles of calcium carbonate, talc, alumina, cellulosic material, and combinations of two or more thereof.

In some embodiments, the substrate layer may be the polymeric core, which comprises a binder polymer and a filler of a Luxury Vinyl Tile (“LVT”), a Vinyl Composition Floor Tile (“VCT”), and a Solid Vinyl Floor Tile (“SVT”). Other suitable substrates that can be used with the wear layer include plastic composite cores and wood plastic composite cores. According to the present invention, “luxury vinyl tile” is an understood term of art in the flooring industry. According to ASTM F 1066, “Vinyl Composition Floor Tile” (VCT) is an accepted official standard category for flooring materials within the flooring industry. Similarly, according to ASTM F 1066, “Solid Vinyl Floor Tile” (SVT) is an accepted official standard category for flooring materials within the flooring industry.

In some embodiments, the flooring panel 10 may further comprise an underlayment layer 50 beneath the substrate layer 20. In some embodiments, the flooring panel 10 may further comprise a top coat 40 atop the wear layer 30. Some embodiments provide that one or more intervening located between the wear layer 30 and the top coat 40. A non-limiting example of such intervening layers include one or more decorative print layers. Some embodiments provide that one or more additional layers can be positioned between the wear layer 30 and the substrate layer 20.

In some embodiments, the top coat 40 may comprise one of the aforementioned vinyl polymers, polyurethane, or polyester, and fillers and additives. In some embodiments, the fillers may comprise abrasive particles, such as alumina, diamond, carbide or silica. In some embodiments, the top coat 40 is a clear coat having about 100% transparency. In some embodiments, the top coat 40 may have a thickness ranging from about 0.25 to about 1.5 mil—including all integers and sub-ranges there-between.

In some embodiments, the underlayment layer 50 may comprise an insulating material, such as cork, PVC, polyurethane, or polyolefin, which may be foamed or solid. In some embodiments, the underlayment layer 50 may have a thickness ranging from about 5 to about 100 mil—including all integers and sub-ranges there-between.

The following examples are prepared in accordance with the present invention. The present invention is not limited to the examples described herein.

### EXAMPLES

### Example 1

The following examples are prepared in accordance with some embodiments of the present invention. The examples are prepared by dry blending the ingredients in a dry blender creating a dry mix. Mixing mill rolls are pre-heated to 350° F. and the dry mix is slowly added to the nip of the mill roll. The dry mix is continually added until a clear film/sheet is developed on the mill roll at which point the sheet is pulled from the mill roll and cooled to room temperature. Each sheet is then tested for tensile energy absorption (TEA) using an Instron tensile strength testing machine.

The following compositions are used for the examples provided herein:
Resin: 100 wt. % polyvinyl chloride polymer (PVC), commercially available from Formosa as Formolon 608;
Impact Modifier 1 (“IM-1”)—100 wt. % of acrylic polymer available from Dow as Paraloid HIA-80
Impact Modifier 2 (“IM-2”)—100 wt. % of copolyamide polymer available from Arkema as Platamid H 1937;
Impact Modifier 3 (“IM-3”)—100 wt. % of a polyester polymer produced from propanediol, isophthalic acid, phthalic acid, and adipic acid;
Impact Modifier 4 (“IM-4”)—48 wt. % of polyester polymer available from BASF as Ecoflex F Blend C1200; 52 wt. % of polyesters similar to the polyester indicated above as IM-3;
Impact Modifier 5 (“IM-5”)—100% of terpolymer: methyl-methacrylate-butadiene-styrene (MBS) available from Dow as Paraloid BTA-730;
Impact Modifier 6 (“IM-6”)—100% of terpolymer: methyl-methacrylate-butadiene-styrene (MBS) available from Dow as Paraloid BTA-717;
PA: Processing Aid—acrylic composition, commercially available from Dow as Paraloid K-120ND
L-1: Lubricant—acrylic composition, commercially available from Dow as Paraloid K-175
L-2: Lubricant—calcium stearate, commercially available from Ferro as Synpro Calcium Stearate 114-40 Veg
S: Stabilizer (S)—Calcium Zinc, commercially available from Baerlocher as Baerostrab B2389.
CS1—commercial MBS impact modified PVC film from Klockner, which contains a low level of the impact modifier.

The following amounts in Table 1 are in grams (g).

TABLE 1

| | | | | | | | | | | Control 2 |
|---|---|---|---|---|---|---|---|---|---|---|
| | Ex. 1 | Ex. 2 | Ex. 3 | Ex. 4 | Ex. 5 | Ex. 6 | Ex. 7 | Ex. 8 | Control 1 | CS1 |
| Resin | 800.0 | 800.0 | 800.0 | 800.0 | 800.0 | 800.0 | 800.0 | 800.0 | 800.0 | |
| IM-1 (Acrylic) | — | — | — | — | 40.0 | — | 40.0 | — | — | |
| IM-2 (Copolyamide) | 96.0 | — | — | — | — | — | — | 48.0 | — | |
| IM-3 (Polyester) | — | 96.0 | — | — | — | — | — | — | — | |
| IM-4 (Polyester) | — | — | 112.2 | — | — | — | — | — | — | |
| IM-5 (MBS) | — | — | — | 40 | — | — | — | — | — | |
| IM-6 (MBS) | — | — | — | — | — | 40 | — | — | — | |
| PA | 8.0 | 8.0 | 8.0 | 8.0 | 16.0 | 8.0 | 8.0 | 8.0 | 16.0 | |
| L-1 | 4.0 | 4.0 | 4.0 | 4.0 | 12.0 | 4.0 | 4.0 | 6.0 | 12.0 | |
| L-2 | 4.0 | 4.0 | 4.0 | 4.0 | 4.0 | 4.0 | 4.0 | 2.0 | 4.0 | |
| S | 8.0 | 8.0 | 8.0 | 8.0 | 8.0 | 8.0 | 8.0 | 8.0 | 8.0 | |
| Total | 920.0 | 920.0 | 936.2 | 864.0 | 880.0 | 864.0 | 864.0 | 872.0 | 840.0 | |
| TEA (J/cm2) | 5.6 | 0.8 | 0.8 | 4.7 | 4.1 | 4.7 | 5.6 | 3.9 | 2.9 | 4.5 |

A flooring sample is produced thermally laminating a conventional LVT substrate and the commercial impact modified film CS1. The flooring sample is machined to provide a locking system. The machining of the flooring sample results in chipping of the CS1 layer. For Ex 2 and Ex 3, polyesters are added in the wear layer composition with the expectation that resilient polymer may provide improved tensile strength. Ex. 5 demonstrates that, as expected, the addition of a high content of processing aids reduces the tensile properties of the wear layer.

### Example 2

Each sample is tested for resistance to yellowing by exposing each test sample to light for a period of time to simulate exposure to sunlight over an extended period of time. A visual assessment is then performed to see if yellowing had occurred in each sample. The results are provided below in Table 2.

TABLE 2

| | Ex. | | Ex. | | Ex. | | | | |
|---|---|---|---|---|---|---|---|---|---|
| | 1 | Ex. 2 | 3 | Ex. 4 | 5 | Ex. 6 | Ex. 7 | Ex. 8 | Control 2 |
| Yellowing | N | N | N | Y | N | Y | N | N | N |

### Example 3

The wear layers of commercially available luxury vinyl tiles from various manufacturers are tested for the presence of a plasticizer in the layer.

TABLE 3

| | | Plasticizer amount |
|---|---|---|
| | Plasticizer | (wt. %) |
| Manufacturer 1 | Y | 19 |
| Manufacturer 2 | Y | 39 |
| Manufacturer 3 | Y | 8 |
| Manufacturer 4 | Y | 9 |
| Manufacturer 5 | Y | 10 |

The wear layer containing a plasticizer, e.g., phthalate plasticizer or nonphthalate plasticizer, such as cyclohexane dicarboxylic acid diisononyl ester. which plasticizer may migrate out to the wear layer surface and require a thermal annealing process to stabilize the layer.

1. A flooring panel comprising:
a substrate layer; and
a wear layer atop the substrate layer, the wear layer comprising a vinyl polymer and an impact modifier, the wear layer being substantially free of plasticizer;
wherein the flooring panel further comprises a top panel surface, a bottom panel surface, and a plurality panel edges extending between the top and bottom panel surfaces to define a perimeter of the flooring panel; wherein the panel edges comprise a first panel edge and a second panel edge opposite the first panel edge; and wherein the first panel edges comprises a first mechanical locking profile and the second panel edge comprises a second mechanical locking profile configured to accept the first mechanical locking profile; and
wherein the wear layer forms a first portion of each of the first and second panel edges; and wherein the substrate layer forms a second portion of each of the first and second panel edges.

2.-3. (canceled)

4. The flooring panel according to claim 1, wherein the first mechanical locking profile comprises a first horizontal locking feature and a first vertical locking feature; and wherein the second mechanical locking profile comprises a second horizontal locking feature configured to cooperate with the first horizontal locking feature to provide horizontal locking and a second vertical locking feature configured to cooperate with the first vertical locking feature to provide vertical locking.

5. The flooring panel according to claim 2, wherein each of the first and second panel edges comprises an upper portion adjacent the top panel surface, the upper portion of the first panel edge comprising a first recess having a recess wall surface and a recess floor surface, and the upper portion of the second panel edge comprises a first flange having a distal surface; and wherein the wear layer forms a portion of the distal surface of the first flange and a portion of the recess wall surface of the first recess.

6. The flooring panel according to claim 1, wherein the vinyl polymer is selected from the group consisting of polyvinyl chloride (PVC), vinylidene chloride, and copolymers of vinyl chloride and alkylene.

7. The flooring panel according to claim 1, wherein the impact modifier is selected from at least one of an acrylic polymer, a vinyl polymer, a copolyamide, or combination of two or more thereof.

8. The flooring panel according to claim 7, wherein the impact modifier comprises the acrylic polymer, which is selected from at least one of a copolymer of methyl methacrylate-ethyl acrylate; a copolymer of styrene-butadiene-styrene; a copolymer of styrene-butadiene-acrylonitrile; a graft copolymer of methyl methacrylate and polybutyl acrylate; or a combination of two or more thereof.

9. The flooring panel according to claim 7, wherein the impact modifier comprises the acrylic polymer that has a core of polybutyl acrylic polymer and a shell of methyl-methacrylate.

10. The flooring panel according to claim 1, wherein the vinyl polymer and impact modifier are present in a weight ratio ranging from about 20:1 to about 6:1 and the impact modifier comprises an acrylic polymer.

11. The flooring panel according to claim 1, wherein the vinyl polymer and impact modifier are present in a weight ratio ranging from about 20:1 to about 6:1 and the impact modifier comprises a copolyamide.

12. The flooring panel according to claim 1, wherein the wear layer has a thickness ranging from about 3 to about 40 mil.

13. The flooring panel according to claim 1, wherein the substrate layer has a thickness ranging from about 60 to about 180 mil.

14. The flooring panel according to claim 1, wherein at least one intervening layer is located between the wear layer and the substrate layer.

15. The flooring panel according to claim 1, wherein the wear layer has a TEA value higher than about 4.6 Joules/cm².

16. The flooring panel according to claim 1, wherein the substrate layer comprises a vinyl composition and the substrate layer being selected from the group consisting of a vinyl composition tile (VCT), a luxury vinyl tile (LVT), and a solid vinyl tile (SVT).

17. A method of forming a flooring panel comprising:
a) forming a laminate structure comprising a substrate and a wear layer atop the substrate, the wear comprising a vinyl polymer and an impact modifier, the wear layer being substantially free of plasticizer; and
h) machining a first edge of the laminate structure to form a first mechanical locking profile, and a second edge of the laminate structure to form a second mechanical locking profile, thereby forming the flooring panel;
wherein the wear layer forms a first portion of each of the first and second mechanical locking profiles and the substrate layer forms a second portion of each of the first and second mechanical locking profiles.

18. The method of forming a flooring panel according to claim 17, wherein a portion of the wear layer is removed during step b).

19. The method of forming a flooring panel according to claim 17, wherein the vinyl polymer and impact modifier are present in a weight ratio ranging from about 20:1 to about 7:1 comprises an acrylic polymer.

20. The method of forming a flooring panel according to claim 17, wherein the vinyl polymer is selected from the group consisting of polyvinyl chloride (PVC), vinylidene chloride, and copolymers of vinyl chloride and an alkylene; and wherein the impact modifier comprises an acrylic polymer, polyester, chlorinated polyethylene, copolyamide, and combination of two or more thereof.
